(19) United States
(12) Patent Application Publication
(10) Pub. No.: US 2025/0163746 A1
(43) Pub. Date: May 22, 2025

(54) WINDOW CONTROL DEVICE FOR CONTROLLING THE UP AND DOWN DISPLACEMENT OF A WINDOW GLASS

(71) Applicant: Volvo Truck Corporation, Göteborg (SE)

(72) Inventors: Rajaraman SWAMINATHAN, BANGALORE, KARNATAKA (IN); Balaganesh THANGAMARIAPPAN, BANGALORE, KARNATAKA (IN); Sonu G VARGHESE, Mavelikara, Kerala (IN); Marasami G., Hosur (IN)

(21) Appl. No.: 18/835,085

(22) PCT Filed: Feb. 17, 2022
(86) PCT No.: PCT/EP2022/053968

§ 371 Date: Aug. 1, 2024

(51) Int. Cl. E05F 15/60; B60J 10/76; H01F 7/02; H01F 7/06

(52) U.S. Cl. CPC E05F 15/60; B60J 10/76; H01F 7/0205; H01F 7/064; E05Y 2201/246; E05Y 2201/462; E05Y 2900/55

(57) ABSTRACT

A window control device for controlling the up and down displacement of a window glass comprising first and second permanent magnet strips attached to window glass, window frame surrounding at least partially the window glass and provided with first and second sets of electromagnets, control system for controlling polarity of the electromagnets and intensity of the magnetic field generated by the first and second sets of electromagnets so that, in locked state, first set of electromagnets adapt to attract the first permanent magnet strip, thus preventing up and down displacement of the window glass, and, in released state of window glass, first set of electromagnets adapt to repel first permanent magnet strip, thus allowing up and down displacement of window glass, and the second set of electromagnets adapt to generate selectively repulsive and/or attractive force on second permanent magnet strip, thus resulting in up or down displacement of window glass.

### TECHNICAL FIELD

The invention relates generally to the automotive field. More particularly, the invention relates to a window control device for controlling the up and down displacement of a window glass.

The invention can be applied in heavy-duty vehicles, such as trucks, buses, and construction equipment. The invention may also be used in other vehicles such as a passenger car.

### BACKGROUND

In heavy trucks, the driver seat is generally positioned at a high position above the ground. Hence, the driver may have difficulties seeing the external areas surrounding the cab since the cab door may impede the driver's view.

A solution to this problem is to arrange a lower window in the lower half of the cab door which provides a downward view of the external surrounding areas. However, this lower window reduces the available space for installing a conventional window winding mechanism arranged in the upper-half of the cab door. The installation of such a lower window may thus lead to the removal of the window winding mechanism, thus preventing any up and down displacement of the upper door window.

### SUMMARY

An object of the invention is to provide a window control device for controlling the up and down displacement of a window glass, which is sufficiently compact to enable its installation inside a cab door equipped with a lower window.

The object is achieved by a control device according to claim 1.

Thus configured, the present invention proposes a raising and lowering mechanism that is relatively compact, and, in particular, that mainly extends in the left and right areas surrounding the upper window glass but not in the intermediate areas extending between the upper and lower window glasses.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a front view of a vehicle door having a window control device according to the present invention,

FIG. 2 is a cross-sectional view taken along the section line A-A of FIG. 1,

FIG. 3a is a schematic view of a window control device according to an exemplary embodiment of the present invention, the window glass being in a locked state and in a lower position,

FIG. 3b is a view similar to FIG. 3a, but the window glass being in a released state,

FIG. 3c is a view similar to FIG. 3b, but the window glass being in an upper position.

### DETAILED DESCRIPTION OF EXAMPLE EMBODIMENTS OF THE INVENTION

Various embodiments of the disclosure are described in detail below. While specific implementations are described, it should be understood that this is done for illustration purposes only. Other components and configurations may be used without departing from the spirit and scope of the disclosure.

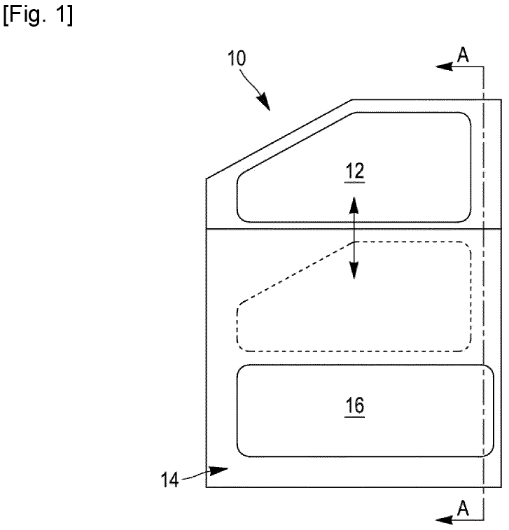

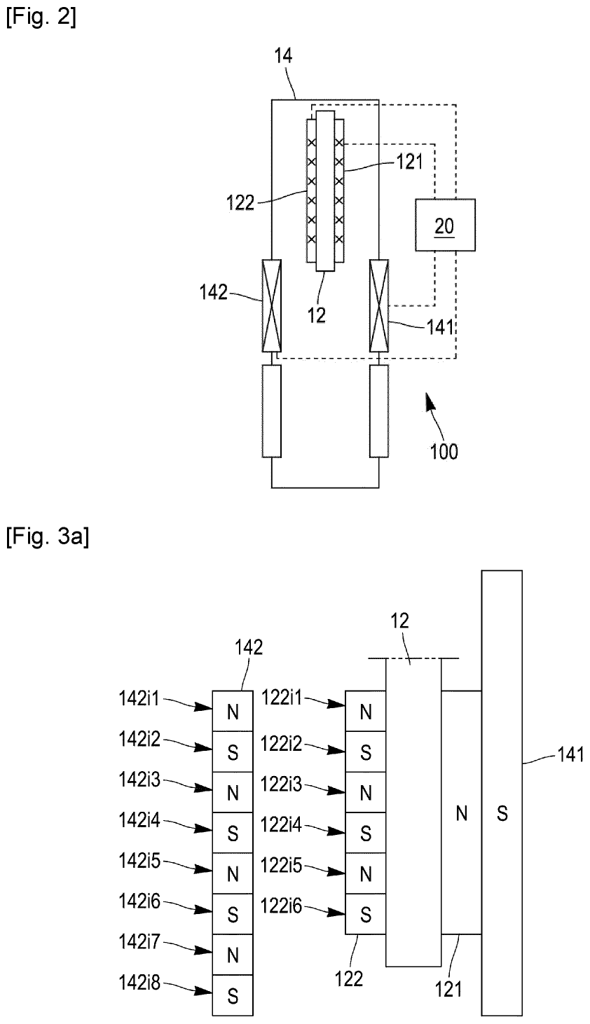

By reference to FIGS. 1 and 2, it is shown a window control device 100 according to the present invention that is mounted to a vehicle door 10. Briefly, the vehicle door 10 includes a window frame 14, an upper window glass 12 slidably mounted thereto and a lower window glass 16 fixedly mounted thereto. The window frame 14 comprises an upper portion 14a and a lower portion 14b, the upper portion 14b being disposed above the lower portion 14b. The upper portion 14a is provided with an upper opening 13 having substantially the same shape as the upper window glass 12 and the lower portion 14b is provided with a lower opening 15 having substantially the same shape as the lower window glass 16, said lower window glass 16 entirely closing said lower opening 15. The upper window glass 12 is movable between a raised position, as illustrated in a continuous line in FIG. 1, in which it entirely closes the upper opening 13 and in which only its end edges are covered by the window frame 14, and a lowered position, as illustrated in discontinuous line in FIG. 1, in which it is completely hidden inside the window frame 14, the upper opening 13 being entirely freed. The upper window glass 12 is movable between its raised position and its lowered position under the action of the window control device 100.

As illustrated in FIG. 2, the window control device 100 comprises first and second permanent magnet strips 121, 122 attached to the upper window glass 12, first and second sets of electromagnets 141, 142 attached to the window frame 14. A control system 20 is operably coupled to the first and second sets of electromagnets 141, 142. The permanent magnet strips 121, 122 may for example be glued or screwed or otherwise fastened to the upper window glass 12.

In the specific embodiment illustrated in FIG. 2, the first and second permanent magnet strips 121, 122 are disposed at opposite sides 12i, 12j of the upper window glass 12, the strips 121, 122 extending along a right end edge thereof that is covered by the window frame 14. The first and second sets of electromagnets 141, 142 are respectively attached to two opposite internal sides 14i, 14j of the window frame 14 so as to face respectively the first and second permanent strips 121, 122.

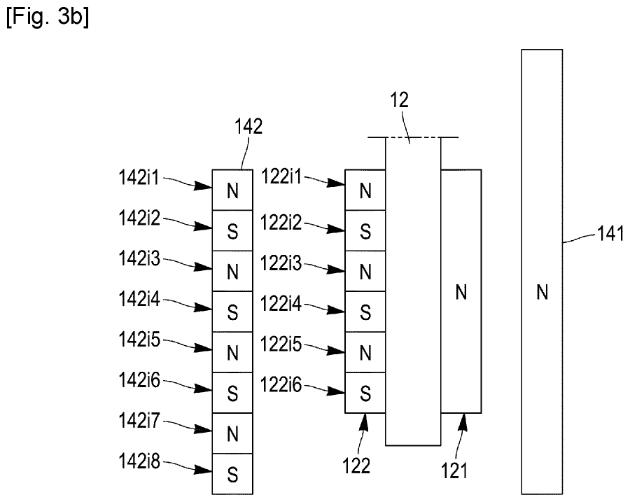

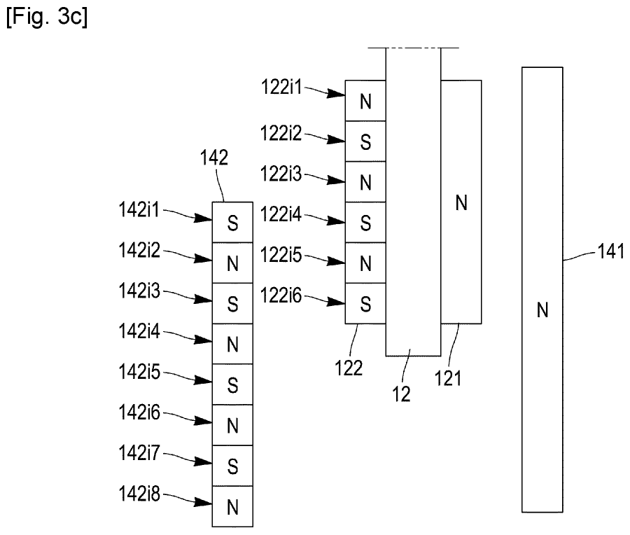

In the specific embodiment illustrated in FIGS. 3a-3c, the first permanent magnet strip 121 comprises a single flat permanent magnet with opposite polarity on each side and the first set of electromagnets 141 facing said permanent magnet comprises only one electromagnet that can selectively have north or south polarity. The second permanent magnet strip 122 has a series of individual permanent magnets 122i1-122i6 arranged in alternating polarity and the second set of electromagnets 142 facing said permanent magnets comprises a series of individual electromagnets 142i1-142i8 that are each controllable to have north or south polarity.

The control system 20 is adapted to control the polarity of the electromagnets 141, 142 and the intensity of the magnetic field generated by said electromagnets 141, 142. As explained in detail in the following paragraphs, this control may allow defining a locked state for the upper window glass 12, in which any up and down displacement of said upper window glass 12 is prevented, and a released state for the upper window glass 12, in which said upper window glass 12 may be raised or lowered.

In particular, in the locked state illustrated in FIG. 3a, the control system 20 is adapted to set the same polarity to the electromagnet 141 as that of the permanent magnet 121 so that the permanent magnet 121 is attracted by the electromagnet 141, thus preventing any up and down displacement of the upper window glass 12.

In the released state illustrated in FIG. 3b, the control system 20 is adapted to set an opposite polarity to the electromagnet 141 than that of the permanent magnet 121 so that the permanent magnet 121 is repelled by the electromagnet 141. The upper window glass 12 thus levitates between the two opposite internal sides 14i, 14j of the window frame 14.

Thereafter, to operate an up and down displacement of the upper window glass 12, the control system 20 is adapted to set the polarity of the electromagnets 142i1-142i8 and the intensity of the magnetic field generated by said electromagnets 142i1-142i8 so as to generate selectively a repulsive force and/or an attractive force on the permanent magnets 122i1-122i6, thus resulting in an up or down displacement of the upper window glass 12.

In particular, to move the upper window glass 12 from its initial position illustrated in FIG. 3b to its final position illustrated in FIG. 3c, the control system 20 may, in a first step, increase the intensity of the magnetic field generated by the electromagnet 142i6 that faces the permanent magnet 122i6 so as to generate a repulsive force on said permanent magnet 122i6, thus leading to an upward movement of the upper window glass 12. When the permanent magnet 122i6 faces the electromagnet 142i5, the control system 20 may, in a second step, modify at the same time the polarities of the electromagnets 142i1-i8 so that the electromagnets 142i1-142i5 that respectively face the permanent magnets 122i2-122i6 have the same polarity as said corresponding permanent magnets 122i2-122i6. By repeating said first and second steps when the permanent magnet 122i6 initially faces the electromagnets 142i5 and 142i4, the upper window glass 12 is finally positioned as illustrated in FIG. 3c.

It is to be understood that the present invention is not limited to the embodiments described above and illustrated in the drawings; rather, the skilled person will recognize that many changes and modifications may be made within the scope of the appended claims.

1. A window control device for controlling the up and down displacement of a window glass comprising:
first and second permanent magnet strips attached to the window glass;
a window frame surrounding at least partially the window glass and being provided with first and second sets of electromagnets; and
a control system for controlling the polarity of the electromagnets and the intensity of the magnetic field generated by the first and the second sets of electromagnets so that, in a locked state, the first set of electromagnets are adapted to attract the first permanent magnet strip, thus preventing any up and down displacement of the window glass, and, in a released state of the window glass, the first set of electromagnets are adapted to repel the first permanent magnet strip, thus allowing an up and down displacement of the window glass, and the second set of electromagnets are adapted to generate selectively a repulsive and/or attractive force on the second permanent magnet strip, thus resulting in an up or down displacement of the window glass.

2. The window control device of claim 1, wherein the first permanent magnet strip comprises a single flat permanent magnet with opposite polarity on each side and the first set of electromagnets comprises only one electromagnet that can have either north or south polarity.

3. The window control device of claim 1, wherein the second permanent magnet strip has a series of individual permanent magnets arranged in alternating polarity and the second set of electromagnets comprises a series of individual electromagnets that can each have either north or south polarity.

4. The window control device of claim 1, wherein the first and the second permanent magnet strips are disposed at opposite sides of the window glass.

5. The window control device of claim 1, wherein the first and the second permanent magnet strips are disposed along an end edge of the window glass that is covered by the window frame.

6. A vehicle door comprising an upper window glass and the window control device of claim 1 for controlling the up and down displacement of the upper window glass.

7. The vehicle door of claim 6, further comprising seals disposed between the upper window glass and the window frame, the seals being adapted to prevent water entry and air leakage.

8. The vehicle door of claim 5, further comprising a lower window glass that is fixedly connected to the window frame.
